(19) United States
(12) Patent Application Publication
(10) Pub. No.: US 2013/0330037 A1
(43) Pub. Date: Dec. 12, 2013

(54) EXCITING A SELECTED MODE IN AN OPTICAL WAVEGUIDE

(71) Applicants: Solomon Assefa, Ossining, NY (US); Huapu Pan, Elmsford, NY (US); Yurii Vlasov, Katonah, NY (US)

(72) Inventors: Solomon Assefa, Ossining, NY (US); Huapu Pan, Elmsford, NY (US); Yurii Vlasov, Katonah, NY (US)

(73) Assignee: INTERNATIONAL BUSINESS MACHINES CORPORATION, Armonk, NY (US)

(21) Appl. No.: 13/527,207

(22) Filed: Jun. 19, 2012

Related U.S. Application Data
(63) Continuation of application No. 13/490,043, filed on Jun. 6, 2012.

(51) Int. Cl. G02B 6/26

(52) U.S. Cl. 385/28

(57) ABSTRACT

A method of exciting a selected light propagation mode in a device is disclosed. At least two light beams are propagated proximate a waveguide of the device substantially parallel to a selected surface of the waveguide. Light is transferred from the at least two beams of light into the waveguide through the selected surface to excite the selected light propagation mode in the waveguide.

### CROSS REFERENCE TO RELATED APPLICATIONS

The present application is a continuation of U.S. patent application Ser. No. 13/490,043, filed on Jun. 6, 2012.

### BACKGROUND

The present invention relates to optical waveguides, and more specifically, to exciting a selected light propagation mode in an optical waveguide.

Optical components, such as photodetectors and electro-absorption modulators are designed for use in various electronics. These optical components include a semiconductor material that interacts with light to create electron-hole pairs. The electron-hole pairs create a measurable current in the presence of an applied bias voltage. Metallic posts or plugs, generally of tungsten, are coupled to the semiconductor material in order to apply this bias voltage. The metallic plugs tend to absorb photons in the semiconductor material, thereby reducing the generation of electron-hole pairs in photodetectors or the transmission of light in electro-absorption modulators.

### SUMMARY

According to one embodiment, a method of exciting a selected light propagation mode in a device includes propagating at least two beams of light proximate a waveguide of the device substantially parallel to a selected surface of the waveguide; and transferring light from the at least two beams of light into the waveguide through the selected surface to excite the selected light propagation mode in the waveguide.

According to another embodiment, a method of operating a photonic device includes propagating light in a first waveguide of the photonic device, the first waveguide having at least two branches; transferring light into a second waveguide of the photonic device from the at least two branches of the first waveguide through a selected surface between the first waveguide and the second waveguide; and applying a bias voltage in the second waveguide to detect electron-hole pairs created in the second waveguide by the transferred light; wherein light is transferred into the second waveguide to excite a selected light propagation mode in the second waveguide.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 shows an exemplary photodetector that uses an exemplary waveguide disclosed herein to excite a selected light propagation mode in one embodiment;

FIG. 2 shows a cross-sectional view of the exemplary photodetector of FIG. 1;

FIG. 3 shows a side view of the exemplary photodetector of FIG. 1;

FIG. 4 shows a top view of an exemplary branched waveguide in one embodiment of the present disclosure;

FIG. 5 shows a top view of an alternate waveguide branch configuration in an exemplary embodiment;

FIG. 6 shows a top view of another waveguide branch configuration in an exemplary embodiment;

FIG. 7 shows a comparison of effective refractive indices for various propagation modes in exemplary waveguides of the disclosure; and

FIG. 8 shows a graph of metal loss for various propagation modes in an exemplary waveguide.

### DETAILED DESCRIPTION

Various optical components include a waveguide made of semiconductor material and rely on an interaction between light propagating through the waveguide and the semiconductor material to produce a result. A fundamental mode of light propagating in a waveguide generally includes a maximum light intensity along a central longitudinal axis of the waveguide. Various optical component designs include metallic plugs coupled to the waveguide proximate this maximum light intensity region. These metallic plugs absorb light which would otherwise interact with the semiconductor material and therefore affect the efficiency of these optical components. The present disclosure provides a method and apparatus of propagating light in the semiconductor material which reduces photon absorption at the metallic plugs.

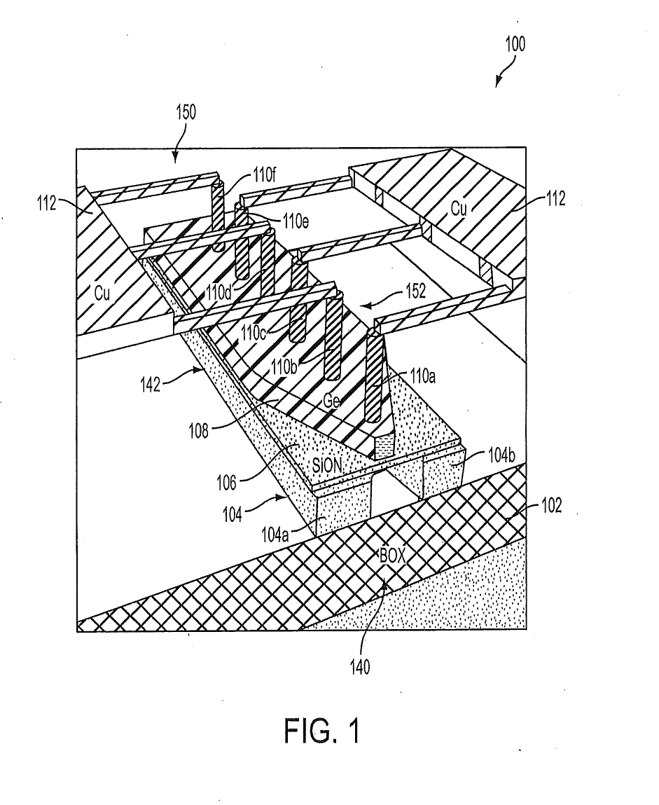

With reference now to FIG. 1, an exemplary photodetector 100 is shown that uses an exemplary waveguide disclosed herein to excite a selected light propagation mode in one embodiment. Although a photodetector is shown for illustrative purposes, the methods disclosed herein may also be used with an electro-absorption modulator or other electronic or optical device. The exemplary photodetector 100 includes a first waveguide 104 for directing light propagation. The first waveguide 104 which may include a silicon waveguide that is formed on a substrate 102 such as a silicon oxide substrate. In an exemplary embodiment, the first waveguide 104 comprises two waveguide branches 104a and 104b separated by a distance that varies. Each of the waveguide branches 104a and 104b provides a path for light propagation from a front location 140 of the first waveguide 104 to a back location 150 of the first waveguide 104. The first waveguide 104 may be coupled to various photonic circuits that provide the light to the first waveguide 104, wherein the photodetector 100 detects light related to the photonic circuits. A second waveguide 108 which may include a waveguide made of germanium or other semiconductor material is overlaid on top of the first waveguide 104 and separated from the first waveguide 104 by a dielectric layer 106. The first waveguide and the second waveguide may be alternately referred to as a guiding waveguide and an absorbing waveguide, respectively. Light propagates in the first waveguide branches in a light mode that propagates along the branches substantially parallel to a selected surface of the second waveguide. In an exemplary embodiment, the refractive index of the second waveguide 108 is greater than the refractive index of the first waveguide 104. Because of this relation between the refractive indices, light traveling in the first waveguide is generally transmitted across an interface between the first waveguide 104 and the second waveguide 108 to therefore propagate in the second waveguide 108.

The second waveguide 108 is generally made of a semiconductor material such as germanium or an indium-gallium-arsenide-phosphide compound. Light transferred into the second waveguide 108 from the first waveguide 104 interacts with the semiconductor material to create electron-hole pairs within the second waveguide 108. The second waveguide 108 includes a row of metallic plugs 110a-110f coupled to a top surface of the second waveguide 108. The metallic plugs are generally aligned in a row that is located along a central longitudinal axis between left side 142 and right side 152 of the second waveguide 108 and extends substantially from the front location 140 to the back location 150. Although six electrodes are shown in FIG. 1 for illustrative purposes, this number of electrodes is not meant as a limitation of the disclosure. In various embodiments, the number of electrodes may be in a range of tens of electrodes to hundreds of electrodes. The metallic plugs are alternately coupled to interconnects 112 to form interdigitated electrodes. An applied voltage at the interconnects 112 induces a bias voltage between adjacent metallic plugs. This bias voltage creates an electric field in the second waveguide that transports the electrons and holes created by the light interacting with the semiconductor material of the second waveguide through the second waveguide and generally to the various plugs 110a-110f.

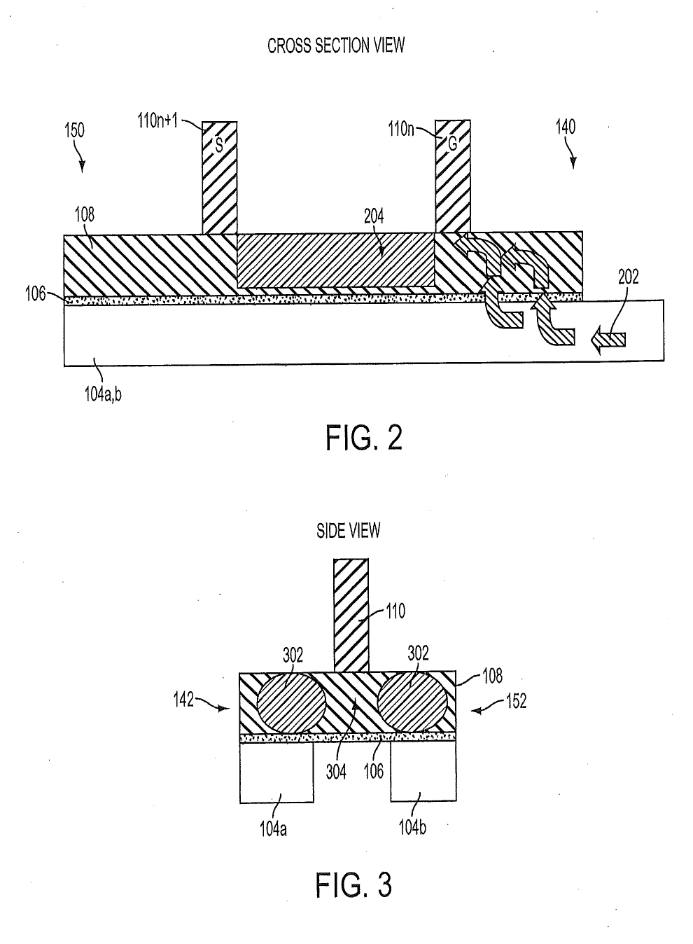

With reference now to FIG. 2, a cross-sectional view of the exemplary photodetector 100 of FIG. 1 is shown as viewed from the left side 142. Light 202 is shown propagating in a light propagation mode from the front location 140 to the back location 150 and being transferred from the first waveguide 104 into the second waveguide 108. An electric field 204 is applied between exemplary metallic plugs 110n and 110n+1. Electrons created by light interacting with the semiconductor material of the second waveguide are attracted to the ground plug 110n (“G”) and the holes created by this interaction are attracted to the signal plug 110n+1 (“S”). Thus, current flows in the second waveguide 108, and may be detected using various measurement devices.

With reference now to FIG. 3, a side view of the exemplary photodetector 100 of FIG. 1 is shown as viewed from the front location 140 of the photodetector 100. Light waveguide branches 104a and 104b are located away from a central axis of the second waveguide along which metallic plugs are located. Therefore, light transferred into the second waveguide from the exemplary waveguide branches excites a propagation mode that has low light intensity in the region proximate the metallic plugs. One exemplary propagation mode is a TE₁₂ mode. The peak intensities of the TE₁₂ mode are indicated by regions 302. A substantial minimal intensity of the TE₁₂ mode is at region 304, which is substantially along the central longitudinal axis of the second waveguide 108 and substantially proximate the exemplary metallic plug 110.

In contrast, a non-branched first waveguide excites a fundamental mode (i.e., TE₁₁ mode) in the second waveguide. The fundamental mode generally includes a maximum light intensity along the central longitudinal axis (e.g. in region 304) of the second waveguide proximate the exemplary metallic plug 110. The metallic plug, as well as other plugs along the central longitudinal axis, therefore absorb light from this maximum light intensity region of the fundamental mode, thereby decreasing the amount of light available for the creation of electron-hole pairs and consequently reducing the efficiency of the photodetector 100. As shown in the exemplary embodiment of FIGS. 1-3, the present disclosure therefore provides a configuration for exciting a light propagation mode (i.e., the TE₁₂ mode) in the second waveguide 108 that has a minimum of light intensity in region 304 proximate the metallic plugs. The metallic plugs thus absorb less light from the TE₁₂ than from a fundamental mode, thereby increasing photodetector efficiency.

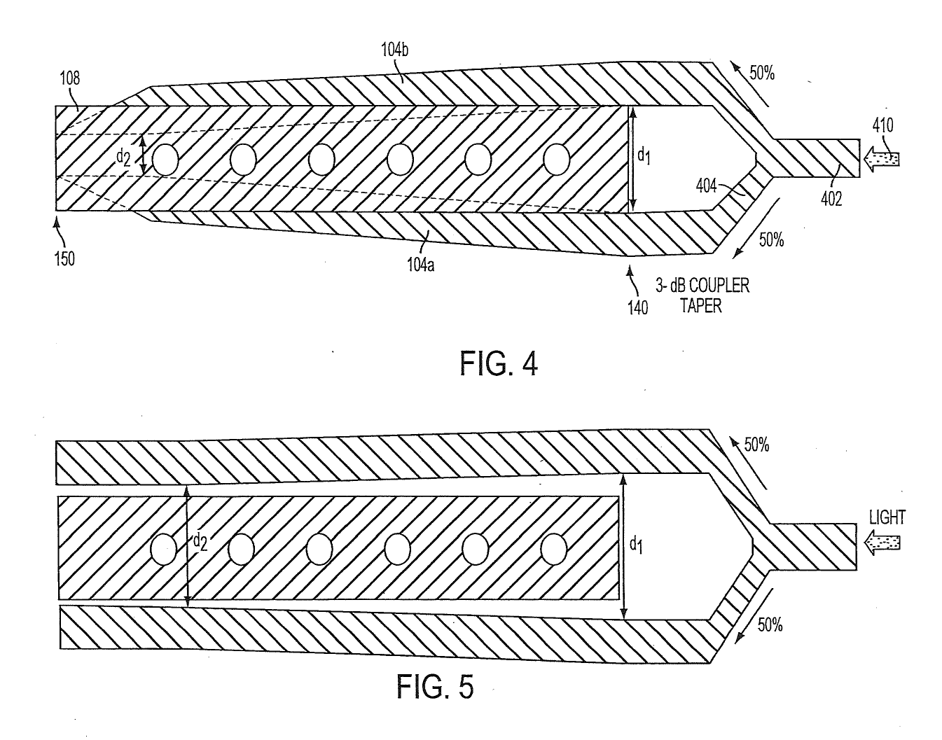

With reference now to FIG. 4, a top view of an exemplary branched wave guide is shown in one embodiment. The waveguide branches 104a and 104b are aligned along a bottom face of the second waveguide 108 and portions of the waveguide branches hidden by the second waveguide from the top view shown in shade. Thus, the exemplary metallic plugs 110a-110f are coupled to the second waveguide at a surface opposite the interface of the first waveguide 104 and the second waveguide 108. Exemplary waveguide section 402 is coupled to a Y-junction beam splitter 404 that splits a light beam travelling in waveguide section 402 substantially evenly into a first beam propagating in the first waveguide branch 104a and a second beam propagating in the second waveguide branch 104b. The waveguide branches 104a and 104b are separated by a separation distance d₁ at the front location 140 of the second waveguide 108 and by a different separation distance d₂ at the back location 150. In general, the separation distance d₁ is greater than the separation distance d₂. Therefore, the waveguide branches are converging along the direction of light propagation. The separation distance d₁ is generally substantially the same as or greater than the width of the second waveguide. The separation d₂ is substantially the same as or greater than a diameter of the metallic plugs 110a-110f. By converging, the waveguide branches gradually overlap the second waveguide 108. Thus, the configuration of FIG. 4 enables excitement of the TE₁₂ mode as the dominant optical mode in the second waveguide 108. In various embodiments, the waveguide branches can be tapered at their back ends or ended in any other suitable manner. In various embodiments, the lengths of branches 104a and 104b can differ from each other by a selected amount, such as a half wavelength or a quarter wavelength of the propagated light to affect a phase relation between the light in each of the waveguide branches, for example, by a half wavelength or a quarter wavelength.

With reference now to FIG. 5, a top view of an alternate wave guide branch configuration is shown in an exemplary embodiment. The waveguide branch 104a runs alongside one face, such as the left side face 142, of the second waveguide 108 and waveguide branch 104b runs alongside an opposing face, such as the right side face 152, of the second waveguide 108. The waveguide branches 104a and 104b are separated by separation distance d₁ at front location 140 and by separation distance d₂ at back location 150. The waveguide branches are therefore converging in the direction of light propagation. Both distances d₁ and d₂ are greater than the width of the second waveguide 108. The TE₁₂ mode is excited in the second waveguide as waveguide branches 104a and 104b approach the second waveguide 108.

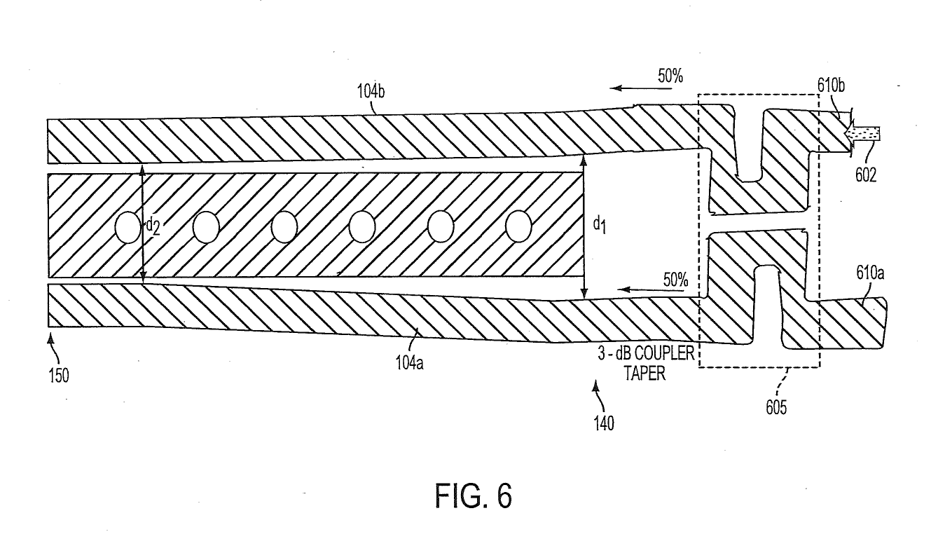

With reference now to FIG. 6, a top view of another waveguide branch configuration is shown in an exemplary embodiment. A directional coupler 605 is used in place of the Y-junction beam splitter of FIGS. 4 and 5. Light 602 propagates along waveguide branch 610a. At the directional coupler 605, the waveguide branches 610a and 610b are brought into close proximity to each other. As a result, about 50% of the light 602 propagates along waveguide 104a and about 50% of the light propagates along waveguide branches 104b after the coupling region 610. The waveguide branches are then separated to separation distance d₁ at front location 140 and converge to separation distance d₂ at the back location 150. Alternatively, light may propagate along waveguide branch 610b and thereby split along waveguide 104a and 104b in about a 50/50 ratio. In various embodiments, the directional coupler may also be used with the waveguide branch configuration of FIG. 4.

In an exemplary embodiment of the photodetector 100, the second waveguide is a germanium (Ge) waveguide that is about 500 nm to about 1500 nm in width and about 150 nm in thickness. The first waveguide is a silicon (Si) waveguide. The metal plugs are tungsten (W) plugs that generally have a diameter of about 150 nanometers (nm) and are separated by about 300 nm. The substrate 102 is generally made of an oxide of silicon (e.g., SiO₂) and the dielectric layer 106 is a silicon oxynitride (SiON) interface. Interconnects are generally made of a conductive material, such as copper. In various embodiments, a width of the second waveguide is selected to allow the propagation of light in the symmetric TE₁₂ mode.

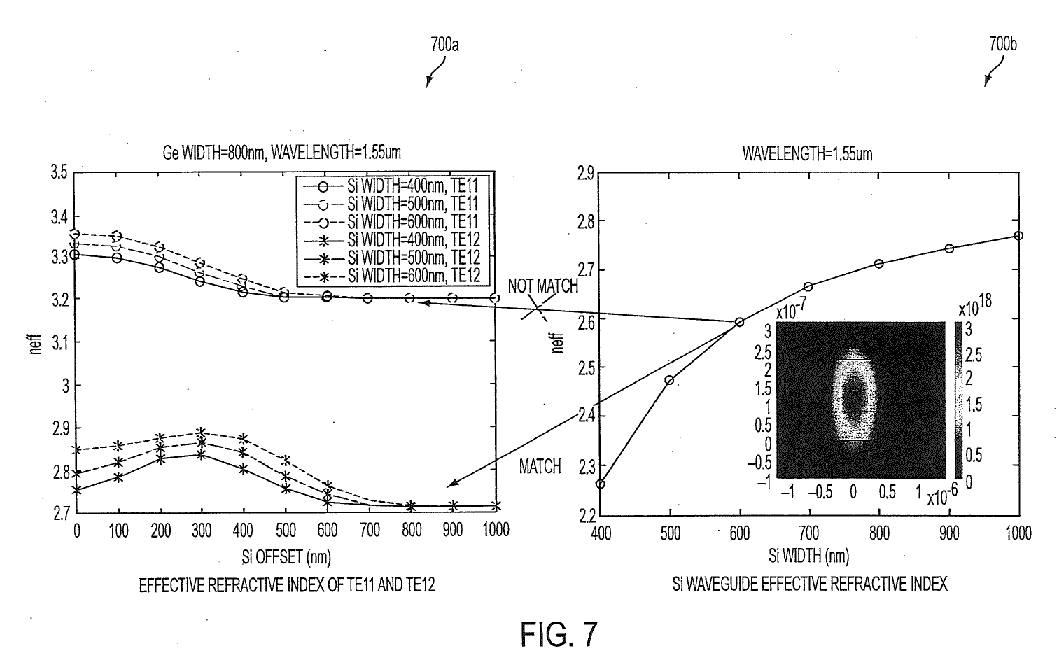

With reference now to FIG. 7, effective refractive indices for various light propagation modes in exemplary waveguides of the disclosure are shown. Graph 700a shows effective refractive index for the various propagation modes in a germanium waveguide (second waveguide). The exemplary germanium waveguide has a width of about 800 nm. The wavelength of the exemplary light is about 1.55 micrometers. The effective refractive index is plotted along the y-axis against silicon offset along the x-axis. Silicon offset refers to the separation distance between the branches 104a and 104b of the silicon waveguide (first waveguide). The effective refractive index for the TE₁₁ modes for various exemplary optical wavelengths (i.e., 400 nm, 500 nm and 600 nm) is between about 3.2 and about 3.4. The effective refractive index for the TE₁₂ modes for the same exemplary optical wavelengths is between about 2.7 and 2.9. Graph 700b shows effective refractive index for various widths of the branches 104a and 104b of the silicon waveguide. Effective refractive index is plotted along the y-axis against the silicon branch width along the x-axis. For waveguide branch widths between 400 nm and 1000 nm, the effective refractive index varies between about 2.3 and about 2.8. Therefore, as the waveguide branches 104a and 104b converge, a separation distance is reached as which the effective refractive index of the silicon waveguide matches the effective refractive index for the TE₁₂ mode of the germanium waveguide. However, such matching does not occur between the effective refractive index of the silicon waveguide and the effective refractive index for the TE₁₁ mode of the germanium waveguide. Therefore, the TE₁₂ mode is the dominant mode excited in the germanium waveguide.

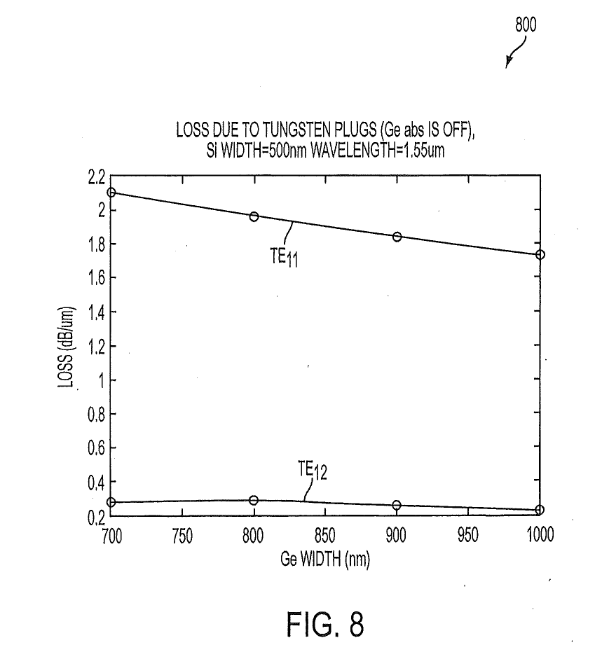

With reference now to FIG. 8, graph 800 shows metal loss for various propagation modes in the second waveguide. Metal loss refers to photon loss due to absorption by the metallic plugs. Metal loss is shown for an exemplary embodiment in which the width of the silicon first waveguide is 500 nm and the exemplary wavelength of light is 1.55 micrometers. The width of the germanium second waveguide ranges between about 700 nm and about 1000 nm. The TE₁₂ mode experiences a metal loss from about 0.2 dB/μm to about 0.3 dB/μm. The TE₁₁ mode experiences a metal loss from about 1.8 dB/μm to about 2.1 dB/μm. Therefore, the TE₁₂ mode experiences less metal loss than the TE₁₁ mode.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comp rises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

While the preferred embodiment to the invention had been described, it will be understood that those skilled in the art, both now and in the future, may make various improvements and enhancements which fall within the scope of the claims which follow. These claims should be construed to maintain the proper protection for the invention first described.

1. A device, comprising:
a first waveguide that includes a section that branches into at least two waveguide branches, each waveguide branch having a beam of light from the section propagating therein; and
a second waveguide having a selected surface proximate the branches of the first waveguide, wherein a light mode propagating in the branches of the first waveguide substantially parallel to the selected surface is absorbed from the branches of the first waveguide into the second waveguide through the selected surface to excite a selected light propagation mode in the second waveguide.

2. The device of claim 1, wherein the second waveguide includes at least one metallic plug coupled thereto and a substantial minimum intensity region of the selected light propagation mode is proximate the at least one metallic plug.

3. The device of claim 2, wherein the at least one metallic plug is coupled to the second waveguide at a surface opposite the selected surface.

4. The device of claim 1, wherein the selected surface includes two opposed surfaces of the second waveguide and wherein one of the at least two branches of the first waveguide is proximate one of the opposed surfaces and the other of the at least two branches of the first waveguide is proximate the other of the opposed surfaces.

5. The device of claim 1, wherein the branches of the first waveguide are converging along a direction of light mode propagation.

6. The device of claim 5, wherein an effective refractive index of the selected mode in the second waveguide substantially matches the effective refractive index of the branches of the first waveguide at a selected separation distance of the converging first waveguide branches.

7. The device of claim 1, wherein the device is selected from the group consisting of: a photo-detector; and an electro-absorption modulator.

8. The device of claim 1, wherein the branches of the first waveguide receive light from at least one of: a Y-junction beam splitter; and a directional coupler.

9. The device of claim 1, wherein a length of one of the first waveguide branches differs from a length of the other of the first waveguide branches by an amount selected to alter a phase relation between the light propagating in the first waveguide branches.

10. The device of claim 1, wherein the selected light propagation mode is a TE₁₂ mode.

11. A photodetector, comprising:
a first waveguide of the photodetector, the first waveguide having two branches;
a second waveguide of the photodetector configured to absorb light from the branches of the first waveguide through a selected surface between the first waveguide and the second waveguide; and
at least one metallic plug configured to apply a bias voltage in the second waveguide to detect electron-hole pairs created in the second waveguide by the absorbed light;
wherein the first waveguide is positioned relative the second waveguide to excite a selected light propagation mode in the second waveguide.

12. The photodetector of claim 11, wherein a substantial minimum intensity region of the selected light propagation mode is proximate the at least one metallic plug.

13. The photodetector of claim 12, wherein the at least one metallic plug is coupled to the second waveguide at a surface opposite the selected surface.

14. The photodetector of claim 11, wherein the selected surface includes two opposed surfaces of the second waveguide and wherein one of the branches of the first waveguide is proximate one of the opposed surfaces and the other branch of the first waveguide is proximate the other of the opposed surfaces.

15. The photodetector of claim 11, wherein the branches of the first waveguide are converging along a direction of light propagation.

16. The photodetector of claim 15, wherein an effective refractive index of the selected mode in the second waveguide substantially matches the effective refractive index of the light propagating in the converging branches at a selected separation distance of the converging branches.

17. The photodetector of claim 11, wherein the branches of the first waveguide receive light from at least one of: a Y-junction beam splitter; and a directional coupler.

18. The photodetector of claim 11, wherein a length of one of the first waveguide branches differs from a length of the other of the first waveguide branches by an amount selected to alter a phase relation between the light propagating in the first waveguide branches.

19. The photodetector of claim 18, wherein the phase relation between light in the two branches of the first waveguide is at least one of: a quarter wavelength of the propagated light; and a half wavelength of the propagated light.

20. The photodetector of claim 1, wherein the selected light propagation mode in the second waveguide is a TE₁₂ mode.
